(19) United States
(12) Patent Application Publication
(10) Pub. No.: US 2023/0119496 A1
(43) Pub. Date: Apr. 20, 2023

(54) FREE VOLTAGE MULTI-CHARGING DEVICE FOR BATTERY

(71) Applicant: BRONINE CO., LTD., Seoul (KR)

(72) Inventor: Sun Hwi MYUNG, Seoul (KR)

(21) Appl. No.: 17/451,288

(22) Filed: Oct. 18, 2021

(51) Int. Cl. H02J 7/00

(52) U.S. Cl. CPC H02J 7/00047; H02J 7/0013; H02J 7/0045

(57) ABSTRACT

The present disclosure relates to a free voltage multi-charging device for a battery for charging batteries of various voltages and types by one charging device because a plurality of charging kits capable of charging batteries of different charging voltages and types may be coupled to one charger main body.

### BACKGROUND

### 1. Technical Field

The present disclosure relates to a free voltage multi-charging device for a battery for charging batteries for use in an electronic product of various voltages and types.

### 2. Description of Related Art

Unless otherwise specified herein, contents described in this section are not to be construed as constituting related art to claims of this application. In addition, although the claims are included in this section, the claims should not be recognized as a related art.

Recently, as electronic products with batteries, such as digital cameras, smartphones, laptops, tablet PCs, and vacuum cleaners have been widely used, rechargeable batteries have been used as power supply devices for smooth operation thereof even outdoors where power is not supplied in real-time. Such rechargeable batteries include lithium-ion (Li-ion) batteries and nickel-hydrogen (Ni-MH) batteries.

Such rechargeable batteries may have varying degrees of charge from depending on the capacity of the battery. When the battery is discharged due to long outdoor activities where real-time charging is impossible, electronic products can no longer be used.

In this case, an extra battery has to be prepared and used or the battery has to be urgently charged in a recharging location such as a nearby cafe, a government office, a vehicle, or a convenience store for continued device usage, causing user inconvenience. In addition, when a user is going on a business trip or the like, the user has to take a charger for charging the battery. However, there is no charger that charges all electronic products of different voltages and types such as razors, smartphones, tablet PCs, and the like, so the user has to inconveniently prepare three different types of chargers. This is because the sizes of batteries and charging voltages are all different in different types of electronic products and across different brands, and the charging terminals of the chargers are also different. As well, when the user has to prepare such an extra battery, the user may spend additional money to purchase the extra battery.

### 3. Related Art Document

Patent Documents
(Patent Document 1) Korean Patent Application Publication No. 10-2015-0094974, Aug. 20, 2015
(Patent Document 2) Korean Patent No. 10-1026223, Mar. 24, 2011
(Patent Document 3) Korean Patent No. 10-1290890, Jul. 23, 2013

### SUMMARY

An aspect of the present disclosure is directed to providing a free voltage multi-charging device for a battery for charging batteries in an electronic product of various voltages and types by one charger.

Embodiments of the inventive concept provide the free voltage multi-charging device for a battery includes: a charger main body having a rectangular shape having a length in one direction, at least one charging socket being formed at one side of a longitudinal direction and provided therein with a display to display a charged state at an upper surface, and coupled to an external power supply to supply power; at least one charging kit including one end detachably coupled to the charging socket by magnetism and an upper surface formed therein with a mounting groove in which the battery is detachably mounted to charge a battery mounted in the mounting groove when the charging kit is coupled to the charging socket; and a control unit provided at the charger main body to determine a charged voltage and a charged condition of the battery mounted in the mounting groove when the charging kit is coupled to the charging socket and supply power necessary for charging from the charger main body after the determination.

Embodiments of the inventive concept provide the free voltage multi-charging device for a battery, wherein the charger main body further comprises a variable transformation circuit, and the variable transformation circuit converts the supplied external power into the power necessary for charging based on the determined charged voltage and charged condition of the battery.

Embodiments of the inventive concept provide the free voltage multi-charging device for a battery, wherein the control unit allows a fine current to flow out to determine the charged voltage and the charged condition of the battery mounted in the mounting groove.

Embodiments of the inventive concept provide the free voltage multi-charging device for a battery, wherein the first and second charging terminals comprise magnetic bodies within circumference of the first and second charging terminals, and the first and second charging terminals are coupled only in a direction determined according to the polarities of the magnetic bodies.

Embodiments of the inventive concept provide the free voltage multi-charging device for a battery, wherein both ends of the magnetic body of the first charging terminal is formed to have different polarities, and both ends of the magnetic body of the second charging terminal also is formed to have different polarities to generate attractive forces from both ends of the magnetic body of the first charging terminal, respectively.

Embodiments of the inventive concept provide the free voltage multi-charging device for a battery, further comprises at least one charging cable, and a first connection terminal and a second connection terminal are provided at both ends of the charging cable, respectively, and the first connection terminal is detachably connected to the first charging terminal of the charger main body through magnetic force, and the second connection terminal is detachably connected to the second charging terminal through magnetic force.

Embodiments of the inventive concept provide the free voltage multi-charging device for a battery, wherein the first and second connection terminals comprise magnetic bodies within circumference of the first and second charging terminals, and the first charging terminal and first connection terminal are coupled only in a direction determined according to the polarities of the magnetic bodies.

Embodiments of the inventive concept provide the free voltage multi-charging device for a battery, further comprises at least one charging cable including a first connection terminal and a second connection terminal provided at both ends of the charging cable, respectively, and at least one transformation control adapter produced exclusively for an electric and electronic product, wherein one side of the transformation control adapter is connected to the second connection terminal of the charging cable, and the other side of the transformation control adapter is connected to a battery of the electric and electronic product directly or indirectly, the transformation control adapter comprises a variable transformation circuit to transmit a preset transformation control signal for the rated charging voltage of the battery of the electric and electronic product to the charger main body through the charging cable when a specific electric signal from the control unit is input through the charging cable, the control unit determines the charged voltage and the charged condition of the battery of the electric and electronic product based on the preset transformation control signal.

Embodiments of the inventive concept provide the free voltage multi-charging device for a battery, wherein the transformation control adapter comprises a PCB for generating a specific signal value.

Embodiments of the inventive concept provide the free voltage multi-charging device for a battery, wherein the charging kit further comprises a variable transformation circuit to transmit a preset transformation control signal for the rated charging voltage of the battery to the charger main body through when a specific electric signal from the control unit is input, the control unit determines the charged voltage and the charged condition of the battery based on the preset transformation control signal.

According to the free voltage multi-charging device for a battery as described above, it is possible to charge batteries of various types by one charging device because a plurality of charging kits capable of charging batteries of different voltages and types may be coupled to be chargeable with one charger main body.

### BRIEF DESCRIPTION OF THE FIGURES

FIG. 1 is a perspective view of a free voltage multi-charging device for a battery according to an embodiment of the present disclosure.

FIG. 2 is an exploded perspective view of a free voltage multi-charging device for a battery according to an embodiment of the present disclosure.

FIG. 3 is another exploded perspective view of a free voltage multi-charging device for a battery according to an embodiment of the present disclosure.

FIG. 4 is a schematic perspective view of a free voltage multi-charging device for a battery according to another embodiment of the present disclosure.

FIG. 5 is an exploded perspective view of a free voltage multi-charging device for a battery according to another embodiment of the present disclosure.

FIG. 6 is a view illustrating a state while in use of a free voltage multi-charging device for a battery according to another embodiment of the present disclosure.

FIG. 7 is a schematic structural view of a free voltage multi-charging device for a battery according to another embodiment of the present disclosure.

FIG. 8 is a perspective view of various embodiments of an adapter in a free voltage multi-charging device for a battery according to another embodiment of the present disclosure.

FIG. 9 is a block diagram illustrating an overall operation of a charging system using an adapter according to yet another embodiment of the present disclosure.

### DETAILED DESCRIPTION

The advantages and features of the present disclosure and methods of achieving them will be apparent from the embodiments that will be described in detail with reference to the accompanying drawings. It should be noted, however, that the present disclosure is not limited to the following embodiments, and may be implemented in various different forms. Rather the embodiments are provided so that this disclosure will be thorough and complete and will fully convey the scope of the present disclosure to those skilled in the technical field to which the present disclosure pertains, and the present disclosure will only be defined by the appended claims. Like reference denotations refer to like elements throughout the specification.

In addition, in the following description of the disclosure, a detailed description of well-known art or functions will be ruled out in order not to unnecessarily obscure the subject matter of the disclosure. In addition, the following terminology is defined based on a function of an embodiment of the disclosure and varied depending on the intent of an operator or a custom. Accordingly, the definition should be made based on contents throughout the specification.

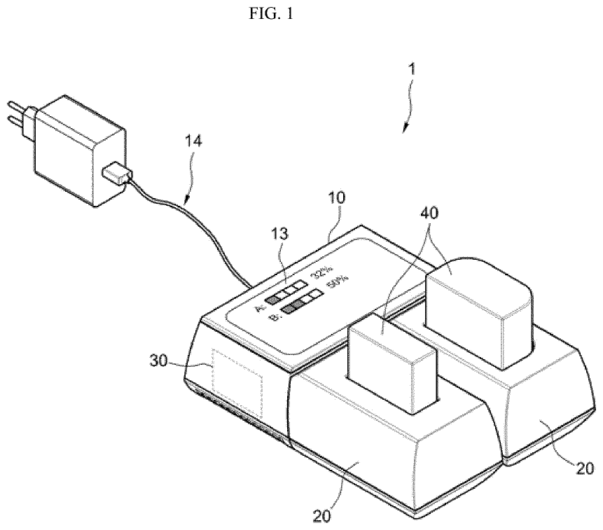

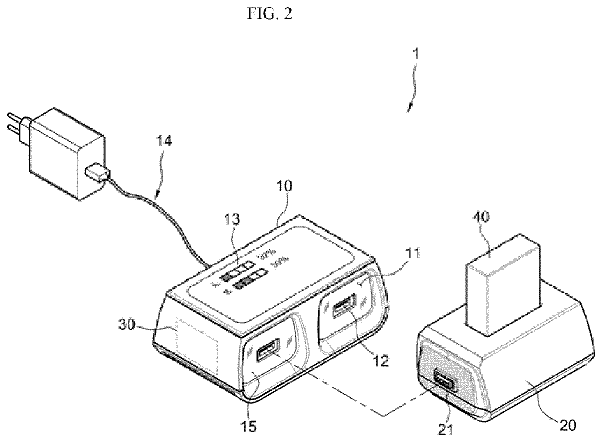

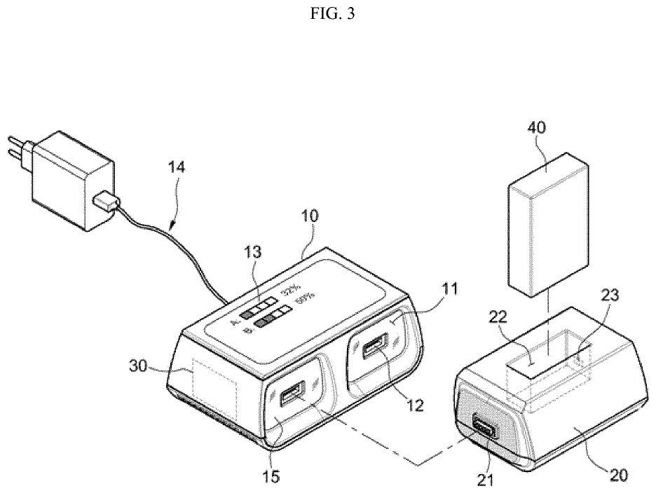

FIGS. 1 to 3 illustrate an embodiment of the present disclosure. FIG. 1 is a perspective view, and FIGS. 2 and 3 are exploded perspective views.

Hereinafter, components of a free voltage multi-charging device for a battery 1 according to an embodiment of the present disclosure and the connection relationship between the components will be described in detail with reference to FIGS. 1 to 3.

Referring to FIG. 1, a charger main body 10 is provided. This charger main body 10 serves to be coupled to a battery 40 and a charging kit 20, to be described later, to be chargeable. This charger main body 10 has a rectangular shape having a length in one direction, and at least one charging socket 11 being formed at one side of a longitudinal direction.

In addition, the charger main body 10 is provided with a display 13 to display a charged state at an upper surface, and is connected to a power cable 14 provided to be coupled to an external power supply to supply power at one side. One end of the power cable 14 is coupled to the charger main body 10, and the other end thereof is formed in the shape of a USB terminal and may be coupled to a power supply device such as a PC, a laptop computer or an external battery. In addition, an adapter capable of being coupled to the USB terminal may be provided, and this adapter may be coupled to an outlet of 220V or 110V or the like. The two batteries 40 may be charged simultaneously or individually through the power cable 14, but the charging voltage may be adjusted and supplied to the optimal charging voltage required for each battery.

In some embodiments, a battery (not shown) may be included in the charger main body 10. The battery 40 may be charged by receiving power from a battery (not shown) in the charger main body 10.

The aforementioned charger main body 10 is formed in a rectangular shape having a length in one direction, which is because the charging socket 11 is arranged along one side of the charger main body 10, and depending on how many charging sockets 11 are formed, the length may be variously changed. In the described content, the charging socket 11 is formed along one side of the charger main body 10 and the shape is designed to be formed in a rectangular shape. However, the charger main body 10 may be formed to have a cube shape, and that the charging socket 11 may be formed not only on one side but also on two or more sides.

The aforementioned power cable 14 is electrically connected to a control unit (or a processor) 30, to be described later, and the control unit 30 is also electrically connected to the display 13. The control unit 30 controls the output of a rated charging voltage corresponding to each battery 40 of electric and electronic products through a variable transformation circuit 31. The abovementioned display 13 displays information related to charging such as charging state, remaining charging time, and charging voltage for each charging kit 20 or for each battery 40 of electric or electronic products being charged, and a separate alarm may be activated when power is fully charged.

The aforementioned charging sockets 11 are formed in equal sizes, and first charging terminal 12 electrically connected to the control unit 30 are provided in the charging sockets 11. The first charging terminal 12 is connected to a second charging terminal 21, to be described later. Thus, the power required for charging the battery 40 is supplied. In some embodiments to be described later, the first charging terminal 12 may be electrically connected to the second charging terminal 21 through a charging cable 50.

As such, these first charging terminals 12 are all formed of terminals of the same standard, and the second charging terminals 21, to be described later, are also all formed in the same standard so that the second charging terminals 21 may be detachably inserted into the first charging terminal 12. In addition, the first charging terminal 12 is formed to be recessed inside and the second charging terminal 21 is formed to protrude so that the second charging terminal 21 may be inserted into the first charging terminal 12, or vice versa.

In addition, a metal member 12 is provided in the aforementioned charging socket 11, and serves to be coupled to the charging kit 20 through magnetic force. The charging socket 11 is formed in a shape of a concave groove therein, so that one end of the charging kit 20 is coupled in a state of insertion thereinto.

In the above-described contents, one end of the charging kit 20 is coupled or press-fit to the charging socket 11 through magnetic force. Separately, the first charging terminal 12 and the second charging terminal 21 are detachably coupled. However, the charging socket 11 and the charging kit 20 may not be coupled, and the first charging terminal 12 and the second charging terminal 21 may be detachably coupled through magnetic force or press-fitting alone.

In some embodiments, a metal member 12a is provided inside the first charging terminal 12, and magnetic force is generated in the second charging terminal 21 so that the metal member 12a of the first charging terminal 12 and a magnetic body 21a coupled through magnetic force may be provided. The charging kit 20 in which the metal member 12a of the first charging terminal 12 and the magnetic body 21a of the second charging terminal 21 mount the battery 40 through magnetic force may be mounted on the charger main body 10.

The metal member 12a of the first charging terminal 12 is formed to be recessed inwardly from an outer wall, and at least a portion of a circumference of the second charging terminal 21 is formed to protrude. Accordingly, when the second charging terminal 21 is attached to the first charging terminal 12 through magnetic force, at least a portion 21a, which protrudes, of the circumference of the second charging terminal 21 is inserted into the recess inward from the outer wall of the metal member 12a. In other words, at least the portion 21a, which protrudes, of the circumference of the second charging terminal 21 is inserted and fitted into a region which is recessed inwardly from the outer wall of the charger main body 10. To this end, at least the portion 21a, which protrudes, of the circumference of the second charging terminal 21 has the shape fixedly inserted into the region which is recessed inwardly from the outer wall of the charger main body 10.

Accordingly, the first charging terminal 12 and the second charging terminal 21 may be coupled in a correct position. In addition, even in the case that an external impact is applied to the charger main body 10, the first charging terminal 12 and the second charging terminal 21 may be easily maintained to be attached through magnetic force.

In some embodiments, a magnetic body 12b is provided within a circumference of the first charging terminal 12 instead of the metal member 12a, and a corresponding magnetic body 21a is also provided within a circumference of the second charging terminal 21 connected thereto. In this case, both ends of the magnetic body 12b of the first charging terminal 12 may be formed to have different polarities. Both ends of the magnetic body 21a of the second charging terminal 21 may also be formed to have different polarities to generate attractive forces from both ends of the magnetic body 12b of the first charging terminal 12, respectively. Accordingly, in a state in which the top and bottom or left and right sides of the first charging terminal 12 or the second charging terminal 21 are reversed, repulsive force is generated between the magnetic bodies 12b and 21a, so that it is difficult to couple the first and second charging terminals 12 and 21. In other words, the first and second charging terminals 12 and 21 may be coupled only in a direction determined according to the polarities of the magnetic bodies 12b and 21a.

In addition, referring to FIGS. 2 and 3, a plurality of charging kits 20 are detachably coupled to the aforementioned charging socket 11 through magnetic force. This charging kit 20 is coupled to the charging groove of the charger main body 10 in a state in which one of the batteries 40 of various voltages and types is mounted in a mounting groove 22, so that the battery 40 is charged. To this end, one end of the aforementioned charging kit 20 is detachably coupled to the charging socket 11 through magnetic force, and the mounting groove 22 in which the battery 40 is detachably mounted is formed on the upper surface. In addition, one end of the charging kit 20 is provided with the second charging terminal 21 electrically connected to the first charging terminal 12.

The mounting grooves 22 of the plurality of charging kits 20 are formed in mutually different shapes such that mutually different voltages and types of batteries are selectively mounted. For example, the mounting groove 22 of a certain charging kit 20 is formed in the shape of allowing mounting of a battery 40 for a digital camera, and the mounting groove 22 of another charging kit 20 is formed in the shape of allowing mounting of a battery 40 for a cleaner. Accordingly, a user may easily charge various voltages and types of batteries 40 with a plurality of charging kits 20 which are provided in one charger main body 10 and have mounting grooves 22 of mutually different shapes required.

In addition, a third charging terminal 23 is provided in the mounting groove 22 to be electrically connected to the battery 40 when the battery 40 is mounted. The position and the size of the third charging terminal 23 may be changed depending on the type of the battery 40 coupled to the mounting groove 22.

In addition, one end of the charging kit 20 is provided with a metal member 15 provided in the charging socket 11 and a magnetic body that exerts attractive force, so that the charging kit 20 is detachably coupled to the charging socket 11 through magnetic force. Accordingly, the charging kit 20 may be stably coupled to the charging socket 11 through magnetic force, and in this case, charging may be performed in a state in which the first charging terminal 12 and the second charging terminal 21 are also stably connected.

In an embodiment of the present disclosure, the charging socket 11 and the charging kit 20 are coupled through magnetic force between the metal member 15 and the magnetic body, but one end of the charging kit 20 may be detachably coupled to the charging socket 11 in a press-fitting manner. In addition, the shape of the first and second charging terminals 12 and 21 is not limited to the shape of a pogo pin connector, either. In some embodiments, the first and second charging terminals 12 and 21 may be any one of a C-type USB terminal, a micro 5-pin terminal, or a lightning 8-pin terminal.

The aforementioned charger main body 10 includes a control unit 30. The control unit 30 may immediately determine a charging condition and a charging voltage of the battery 40 mounted in the mounting groove 22 such that power necessary for charging is supplied from the charger main body 10.

In other words, the control unit 30 senses the coupling when the charging kit 20, in which the battery 40 is mounted, is coupled into the charging groove of the charger main body 10 or when the charging kit 20, in which the battery 40 is mounted, is coupled into the charging socket 11, allows a fine current to flow out to analyze the charging voltage and type of the relevant battery 40, and supplies a charging voltage matched to the analysis when the analysis is finished, thereby charging the battery 40.

In addition, the aforementioned control unit 30 may further include a function of predicting a life of the battery 40. In other words, by applying an AC signal having a single frequency to the battery 40 side from the control unit 30, the AC impedance of the battery 40 is measured, and the life of the battery 40 is predicted using the same. The predicted life of the battery 40 may be displayed on the aforementioned display 15. Since the method of predicting the life of a battery using such an AC signal is a presently known technology, a further detailed description thereof will be omitted for the sake of simplicity of the specification.

Hereinafter, the overall usage of the free voltage multi-charging device for a battery 1 according to an embodiment disclosed herein will be described with reference to FIG. 1 in detail.

As the power cable 14 of the charger main body 10 is connected to the external power supply, power may be supplied from the external power supply. Then, the charging kit 20 matched to the type of the battery 40 which needs to be charged is selected, and the battery 40 is coupled into the mounting groove 22 of the charging kit 20. In this case, the battery 40 is connected, to be chargeable, to the third charging terminal 23 in the mounting groove 22.

Then, the charging kit 20 is coupled into the charging groove of the charger main body 10. In this case, the magnetic body provided at one end of the charging kit 20 and the metal member 15 provided in the charging groove are fixed through magnetic force. Simultaneously, the second charging terminal 21 of the charging kit 20 is electrically connected to the first charging terminal 12 in the charging socket 11.

When the coupling is completed, the voltage and type of the relevant battery 40 is analyzed by the control unit 30. When the analysis is terminated, the charging of the battery 40 is started by a charging voltage matched to the analysis. The charging state is displayed through the display 13 during the charging. When the charging is completed, the charging terminated is notified using an alarm.

According to the free voltage multi-charging device for a battery 1 as described above, it is possible to charge batteries 40 of various types by one charging device because a plurality of charging kits 20 capable of charging batteries 40 of different voltages and types may be coupled, to be chargeable, to one charger main body 10.

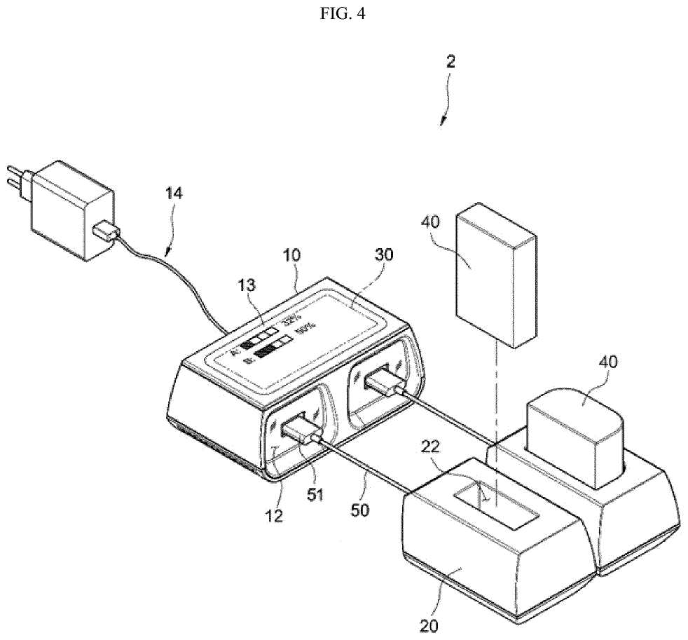

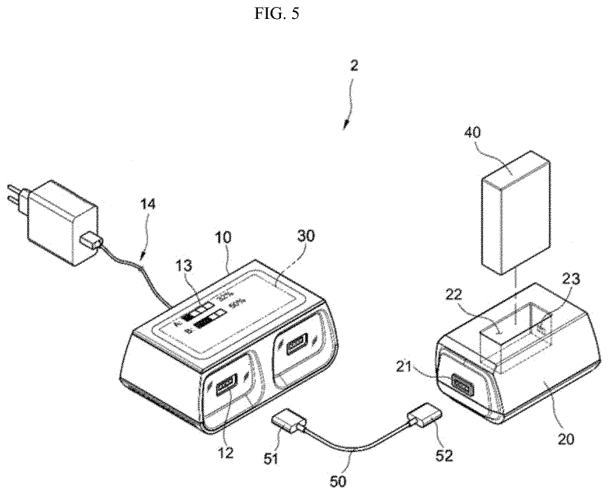

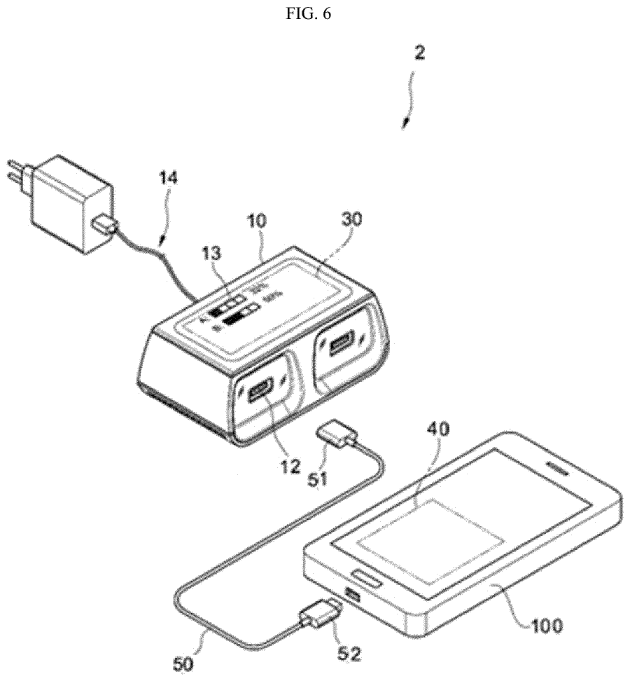

FIGS. 4 to 6 illustrate another embodiment of the present disclosure, FIG. 4 is a perspective view, FIG. 5 is an exploded perspective view, and FIG. 6 is a view illustrating a state while in use.

Hereinafter, components of a free voltage multi-charging device for a battery 2 according to another embodiment of the present disclosure and the connection relationship between the components will be described in detail with reference to FIGS. 4 to 6. However, differences from the free voltage multi-charging device for a battery 1 according to an embodiment of the present disclosure will be mainly described.

The free voltage multi-charging device for a battery 2 illustrated in FIGS. 4 and 5 further include the charging cable 50 for connecting the second charging terminal 21 for charging the battery 40 of an electric and electronic product to the first charging terminal 12 of the charger main body 10.

The charging cable 50 electrically connects the first charging terminal 12 of the charger main body 10 and the second charging terminal 21 for charging the battery 40 of an electric and electronic product to serves to supply power required for charging the battery 40 to the second charging terminal 21. In addition, the charging cable 50 serves as a conducting wire through which the voltage measurement current for determining the rated charging voltage of the battery 40 of the electric and electronic product is applied to the battery 40.

A first connection terminal 51 and a second connection terminal 52 are provided at both ends of the charging cable 50, respectively. The first connection terminal 51 is detachably connected to the first charging terminal 12 of the charger main body 10, and power supplied from the charger main body 10 is supplied to the battery 40 through the second charging terminal 21 connected to the second connection terminal 52.

The first and second connection terminals 51 and 52 are formed of a pogo pin connector having 4 pins, 5 pins or 6 pins, and may be directly connected to the first and second charging terminals 12 and 21 of the charger main body 10 through magnetic force, respectively, as illustrated in FIG. 4. However, in some embodiments, the first and second connection terminals 51 and 52 are formed in any one of a C-type USB terminal, a micro 5-pin terminal, and a lightning 8-pin terminal, and may be inserted and coupled to the first charging terminal 12 of the charger main body 10 and a charging terminal 100a for charging a battery 40 of an electric and electronic product, and may be directly connected to the output terminal 11 of the charger man body 10 and the charging terminal 40 for charging the battery 40 of the electric and electronic product by various detachable coupling methods such as press-fitting, groove-protrusion structure, and the like.

A magnetic body (not shown) is provided in a circumference of the first connection terminal 51 and the second connection terminal 52 of the charging cable 50, and the corresponding magnetic bodies 12b and 21a are also provided in the circumference of the first charging terminal 12 of the charger main body 10 connected thereto and the circumference of the second charging terminal 21 for charging the battery 40 of an electric and electronic product so that the electrical connection between the first charging terminal 12 and the second charging terminal 21 by the charging cable 50 may be made quickly and easily. Here, both ends of the magnetic body (not shown) of the first and second connection terminals (51, 52) and the both ends of the magnetic bodies 12b and 21a of the first and second charging terminals 12 and 21 are formed to have different polarities, respectively, so that the first connection terminal 51 and the first charging terminal 12, the second connection terminal 52 and the second charging terminal 21 may only be coupled in a predetermined direction, respectively.

In addition, the charging cable 50 includes an ordinary data transmission line and a connection pin, and thus may also be used as an ordinary data transmission cable.

When the second charging terminal 21 for charging the battery 40 of an electric and electronic product is coupled to the first charging terminal 12 of the charger main body 10 by the charging cable 50, the control unit 30 outputs a voltage measurement current (a fine current) for sensing the rated charging voltage to the battery 40 through the charging cable 50 to analyze the rated charging voltage of the corresponding battery 40. When the analysis is completed, the control unit 30 outputs a rated charging voltage matched to the corresponding battery 40 so that the battery 40 is charged regardless of the rated charging voltage condition using the variable transformation circuit 31.

As illustrated in FIG. 6, the charging terminal 100a of an electric and electronic product 100 may be formed on one side of the electric and electronic product 100 in which the battery 40 is built-in such as a mobile phone or a notebook computer to be charged. The second connection terminal 52 of the charging cable 50 may be coupled to the charging terminal 100a of the electric and electronic product 100. In some embodiments, regular power may be supplied to the electric and electronic product 100 from the charger main body 10 through the charging cable 50.

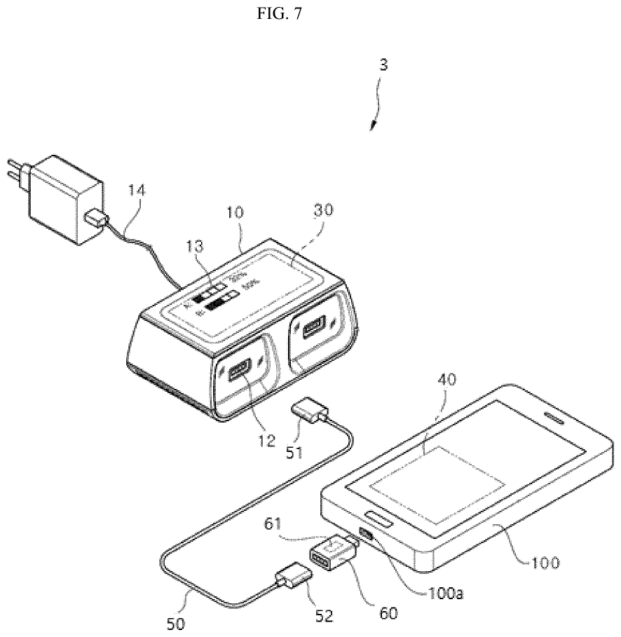

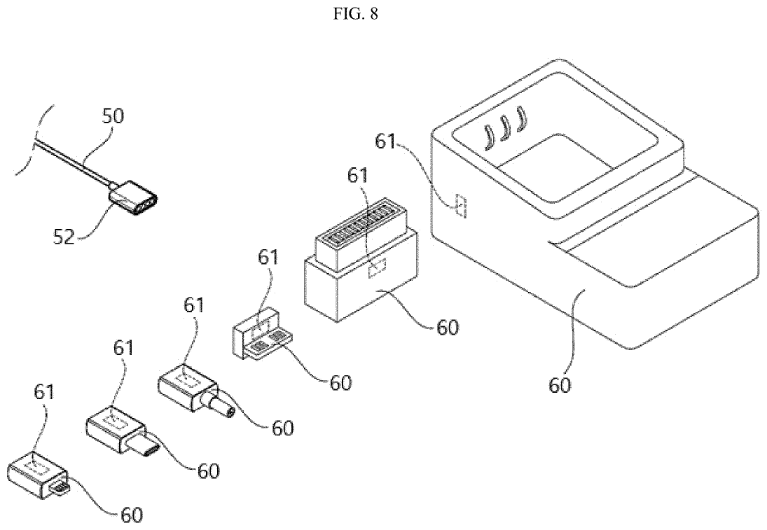

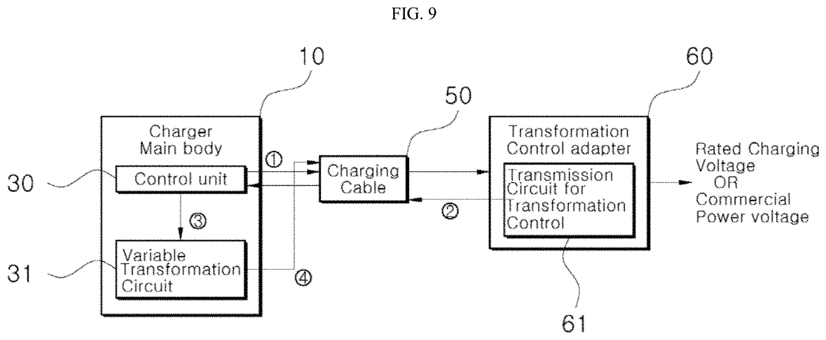

FIGS. 7 to 9 illustrate yet another embodiment of the present disclosure, FIG. 4 is a perspective view, FIG. 7 is a schematic structural view, FIG. 8 is a perspective view, and FIG. 9 is a block diagram.

Hereinafter, components of a free voltage multi-charging device for a battery 2 according to yet another embodiment of the present disclosure and the connection relationship between the components will be described in detail with reference to FIGS. 7 to 9. However, differences from the free voltage multi-charging devices for a battery 1 and 2 according to an embodiment of the present disclosure will be mainly described.

Referring to FIG. 7, a free voltage multi-charging device for a battery 3 further includes a transformation control adapter 60 having one side connected to the second connection terminal 52 of the charging cable 50 and the other side directly or indirectly connected to the battery 40 of the electric and electronic product 100. To this end, one side and the other side of the transformation control adapter 60 may be manufactured in a form that may be electrically connected to correspond to the standard and form of the second connection terminal 22 and the charging terminal 100a of the electric and electronic product 100, respectively.

For example, when a magnetic body (not shown) is formed in a circumference of the second connection terminal 52, a magnetic body (not shown) may also be formed in a circumference of one side of the transformation control adapter 60. Both ends of the magnetic body (not shown) of the second connection terminal 52 and both ends of the magnetic body (not shown) on one side of the transformation control adapter 60 are formed to have different polarities, respectively, so that the second connection terminal 52 and the transformation control adapter 60 may be coupled only in a predetermined direction.

The transformation control adapter 60 includes a transmission circuit 61 for transformation control that transmits a preset transformation control signal for the rated charging voltage of the battery 40 of the electric and electronic product 100 or a commercial DC voltage of the electric and electronic product 100 to the charger main body 10 through the charging cable 50 when a specific electric signal is input through the charging cable 50.

Referring to FIG. 8, the rated charging voltage is different for each battery 40, the commercial DC voltage is different for each electric and electronic product 100, and the shape of the charging terminal 100a for each electric and electronic product 100 may be different. Accordingly, the transformation control adapter 60 may be individually manufactured for each electric and electronic product 100. The transformation control adapter 30 may also be formed in the form of an ordinary charging adapter or a connector for commercial power supply, but may also be formed in the form of a charging kit to which the battery 40 may be directly coupled. For example, the charging kit 20 of FIG. 3 may also serve as a kind of the transformation control adapter 30. To this end, the charging kit 20 may include a transmission circuit 61 for transformation control.

The charger main body 10 may serve to output the rated charging voltage of the battery 40 or to output a commercial DC voltage for use of the electric and electronic product 100.

To this end, the charger main body 10 includes a variable transformation circuit 31 converting the supplied external power into a rated charging voltage or commercial DC voltage. Specifically, the variable transformation circuit 31 is a kind of a transformation circuit converting external power supplied through the power cable 14 into a rated charging voltage suitable for charging the battery 40 or a commercial DC voltage of the electric and electronic product 100 according to a specific transformation control signal and outputs the same through the charging terminal 12, and includes an ordinary variable transformation circuit in which the output voltage is adjustable by adjusting a transformation ratio according to the magnitude of the transformation control signal.

The control unit 30 transmits an electric signal to the transformation control adapter 60 through the charging cable 50 and drives the variable transformation circuit 11 according to the transformation control signal received from the transformation control adapter 60.

Hereinafter, the overall operation of the free voltage multi-charging device for a battery 3 according to yet another embodiment of the present disclosure will be described with reference to FIG. 9.

When it is desired to charge the battery 40 of a specific electric and electronic product 100, with the power cable 14 of the charger main body 10 connected to the external power source, one side of the charging cable 50 is connected to the first charging terminal 12 of the charger main body 10, and the other side of the charging cable 50 is coupled to the transformation control adapter 60 produced exclusively for the electric and electronic product 100, the transformation control adapter 60 is connected to the charging terminal 100a for charging the battery 40 of electric and electronic product 100. In some embodiments, when the transformation control adapter 60 is in the shape of the charging kit 20, the battery 40 may be inserted into the charging kit 20.

A specific electric signal, that is, a specific fine current for measuring a rated charging voltage or a commercial DC voltage, is output by the control unit 30 in the charger main body 10, and is input to the transmission circuit 61 for transformation control of the transformation control adapter 60 through the charging cable 50.

The transmission circuit 61 for transformation control transmits a preset transformation control signal with respect to the rated charging voltage of the battery 40 of the electric and electronic product 100, that is, a current signal of a specific magnitude, to the charger main body 10 through the charging cable 50. The control unit 30 controls the variable transformation circuit 11 of the charger main body to immediately convert the external power applied through the power cable 13 to the rated charging voltage of the battery 40 of the corresponding electric and electronic product 100 or the commercial DC voltage of the corresponding electric and electronic product to be output.

Accordingly, the charging system using an adapter according to an embodiment of the present disclosure includes the transformation control adapter 60 provided with the transmission circuit 61 for transformation control that transmits a preset transformation control signal with respect to the rated charging voltage of the battery 40 of the electric and electronic product 100 or the commercial DC voltage of the electric and electronic product 100 to the charger main body 10 through the charging cable 50 in reverse when inputting an electric signal through the charging cable 50. Accordingly, according to the transformation control signal received from the transmission circuit 61 for transformation control of the transformation control adapter 60, the variable transformation circuit 31 of the charger main body 100 is immediately driven, so that the rated charging voltage of the battery 40 of the corresponding electric and electronic product 100 or the commercial DC voltage of the electric and electronic product 100 may be provided immediately. Accordingly, the battery 40 of the corresponding electric and electronic product 100 may be quickly charged by the rated charging voltage, and the commercial DC voltage may be quickly supplied to the corresponding electric and electronic product 100.

According to the free voltage multi-charging device for a battery 3, when the voltage measurement current is applied, a control signal for the rated charging voltage value or commercial power voltage value of the corresponding electric and electronic product is provided to the charger main body 10, and it is possible to omit a process of determining a rated charging voltage or commercial power voltage value through a fine current.

In addition, there is no need to include a transformation circuit converting the charging voltage provided from the charger main body 10 to match the rated charging voltage of the battery 40 of the corresponding electric and electronic product 100 in the transformation control adapter 60. It is only necessary to include a circuit in the form of a PCB for generating a specific signal value, and thus a more compact transformation control adapter may be used.

While the present disclosure has been described with reference to exemplary embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A free voltage multi-charging device for a battery, the device comprising:
a charger main body having a rectangular shape having a length in one direction, at least one charging socket being formed on one side in a longitudinal direction and provided therein with a display to display a charged state at an upper surface, and coupled to an external power supply to supply power;
at least one charging kit including one end detachably coupled to the charging socket through magnetism and an upper surface formed therein with a mounting groove in which the battery is detachably mounted to charge a battery mounted in the mounting groove when the charging kit is coupled to the charging socket; and
a control unit provided at the charger main body to determine a charged voltage and a charged condition of the battery mounted in the mounting groove when the charging kit is coupled to the charging socket, supply power necessary for charging from the charger main body after the determination,
wherein:
the charging socket is formed in a shape of a concave groove therein, so that one end of the charging kit is inserted thereinto, a first charging terminal electrically connected to the control unit is provided in the charging socket, and a second charging terminal electrically connected to the first charging terminal is provided at one end of the charging kit,
the first charging terminal is formed to be recessed inside and the second charging terminal is formed to protrude so that the second charging terminal is inserted into the first charging terminal, and the first charging terminal and the second charging terminal are each formed in the same standard regardless of the charging kit,
when the charging kit is coupled to the charging socket through magnetic force, the first charging terminal and the second charging terminal are electrically connected for charging,
the mounting grooves of the plurality of charging kits are formed in mutually different shapes such that mutually different voltages and types of batteries are selectively mounted, and a third charging terminal is provided in the mounting groove to be electrically connected to the battery when the battery is mounted.

2. The free voltage multi-charging device for a battery of claim 1, wherein the charger main body further comprises a variable transformation circuit, and the variable transformation circuit converts the supplied external power into the power necessary for charging based on the determined charged voltage and charged condition of the battery.

3. The free voltage multi-charging device for a battery of claim 1, wherein the control unit allows a fine current to flow out to determine the charged voltage and the charged condition of the battery mounted in the mounting groove.

4. The free voltage multi-charging device for a battery of claim 1, wherein the control unit analyzes a life of the battery by measuring an AC impedance of the battery and then display the analyzed result through the display.

5. The free voltage multi-charging device for a battery of claim 1, wherein the first and second charging terminals comprise magnetic bodies within circumference of the first and second charging terminals, and the first and second charging terminals are coupled only in a direction determined according to the polarities of the magnetic bodies.

6. The free voltage multi-charging device for a battery of claim 5, wherein both ends of the magnetic body of the first charging terminal is formed to have different polarities, and both ends of the magnetic body of the second charging terminal also is formed to have different polarities to generate attractive forces from both ends of the magnetic body of the first charging terminal, respectively.

7. The free voltage multi-charging device for a battery of claim 1, further comprises at least one charging cable, and a first connection terminal and a second connection terminal are provided at both ends of the charging cable, respectively, and the first connection terminal is detachably connected to the first charging terminal of the charger main body through magnetic force, and the second connection terminal is detachably connected to the second charging terminal through magnetic force.

8. The free voltage multi-charging device for a battery of claim 1, wherein the first and second connection terminals comprise magnetic bodies within circumference of the first and second charging terminals, and the first charging terminal and first connection terminal are coupled only in a direction determined according to the polarities of the magnetic bodies.

9. The free voltage multi-charging device for a battery of claim 1, further comprises at least one charging cable including a first connection terminal and a second connection terminal provided at both ends of the charging cable, respectively, and
at least one transformation control adapter produced exclusively for an electric and electronic product,
wherein one side of the transformation control adapter is connected to the second connection terminal of the charging cable, and the other side of the transformation control adapter is connected to a battery of the electric and electronic product directly or indirectly,
the transformation control adapter comprises a variable transformation circuit to transmit a preset transformation control signal for the rated charging voltage of the battery of the electric and electronic product to the charger main body through the charging cable when a specific electric signal from the control unit is input through the charging cable,
the control unit determines the charged voltage and the charged condition of the battery of the electric and electronic product based on the preset transformation control signal.

10. The free voltage multi-charging device for a battery of claim 1, wherein the transformation control adapter comprises a PCB for generating a specific signal value.

11. The free voltage multi-charging device for a battery of claim 1, wherein the charging kit further comprises a variable transformation circuit to transmit a preset transformation control signal for the rated charging voltage of the battery to the charger main body through when a specific electric signal from the control unit is input,
the control unit determines the charged voltage and the charged condition of the battery based on the preset transformation control signal.
